(19) United States
(12) Patent Application Publication
(10) Pub. No.: US 2023/0419761 A1
(43) Pub. Date: Dec. 28, 2023

(54) MOVING BODY QUEUE MANAGEMENT SYSTEM AND MOVING BODY QUEUE MANAGEMENT METHOD

(71) Applicant: Hitachi, Ltd., Chiyoda-ku, Tokyo (JP)

(72) Inventors: Satoshi KUWAMOTO, Tokyo (JP); Yu KITANO, Tokyo (JP); Akinori ASAHARA, Tokyo (JP)

(73) Assignee: Hitachi, Ltd., Chiyoda-ku, Tokyo (JP)

(21) Appl. No.: 18/039,416

(22) PCT Filed: Sep. 3, 2021
(86) PCT No.: PCT/JP2021/032479

§ 371 Date: May 30, 2023

(30) Foreign Application Priority Data
Dec. 25, 2020 (JP) 2020-216312

(51) Int. Cl. G07C 11/00; G06Q 10/0631

(52) U.S. Cl. CPC G07C 11/00; G06Q 10/06311; G07C 2011/04

(57) ABSTRACT

Provided is a moving body queue management system that can plan an estimated queue line of moving bodies in consideration of a main trajectory. Provided is the moving body queue management system that manages a queue of the moving bodies, the moving body queue management system including: an information management unit configured to manage moving information regarding movement of a moving body; and an estimated queue line planning unit configured to plan an estimated queue line for guiding the moving body to the queue based on the moving information such that at least a part of the queue of the moving bodies crosses a main trajectory.

### BACKGROUND OF THE INVENTION

### 1. Field of the Invention

The present invention relates to a moving body queue management system and a moving body queue management method.

### 2. Description of Related Art

In facilities such as stations, airports, or commercial stores, a queue for a service may be formed. When a queue for a service is formed during congestion, the queue interferes with the passage of pedestrians who do not relate to the service, and thus a queue rope is used or a staff guides the pedestrians to adjust the queue line.

Recently, in order to reduce manpower cost, a technique of automating the adjustment of a queue line of facility users is required. As a technique in the related art of guiding people to positions to be lined up on a queue, JP2020-086508A and JP2015-108913A are known.

JP2020-086508A discloses a technique of determining a position of the next person to be lined up on a predetermined queue line based on an end position of the queue identified by image recognition or the like and displaying guidance information on a digital signage or the like to guide a user.

JP2015-108913A discloses a technique of subtracting the number of regular staffs from a predictive value of the number of users in a transport facility such as a railway to acquire the number of people who cannot use the facility and making a guidance plan based on the person capacity in a congestion area positioned in a station.

In the techniques described in JP2020-086508A and JP2015-108913A, a trajectory other than a queue is not considered, and thus a relationship between the trajectory other than the queue and the queue cannot be adjusted. Therefore, a queue extends to an area having a large amount of foot traffic, which may interfere with pedestrians.

### SUMMARY OF THE INVENTION

The present invention has been made in consideration of the above-described problems, and an object thereof is to provide a moving body queue management system and a moving body queue management method, in which an estimated queue line of moving bodies can be planned in consideration of a main trajectory.

In order to achieve the object, according to one aspect of the present invention, there is provided a moving body queue management system that manages a queue of moving bodies, the moving body queue management system including: an information management unit configured to manage moving information regarding movement of a moving body; and an estimated queue line planning unit configured to plan an estimated queue line for guiding the moving body to the queue based on the moving information such that at least a part of the queue of the moving bodies crosses a main trajectory.

According to the present invention, the estimated queue line for guiding the moving body to the queue can be planned such that at least the part of the queue of the moving bodies crosses the main trajectory.

### BRIEF DESCRIPTION OF THE DRAWINGS

FIG. 1 is an overall schematic diagram illustrating a population flow guidance system as “moving body queue management system” according to an embodiment;

FIG. 2 is a block diagram illustrating a basic configuration of the population flow guidance system;

FIG. 3 is a diagram illustrating a hardware configuration of the population flow guidance system;

FIG. 4 is a flowchart illustrating an overall process of the population flow guidance system;

FIG. 5 is an example of a trajectory table of a trajectory database;

FIG. 6 is an example of a queue state table of a queue state database;

FIG. 7 is an example of an obstacle table of a map database;

FIG. 8 is an example of a passage restriction area table of the map database;

FIG. 9 is an example of a main trajectory table of a main trajectory database;

FIG. 10 is an example of a queue line definition condition table of a condition database;

FIG. 11 is an example of a queue estimated number-of-people table of the condition database;

FIG. 12 is an example of an estimated queue line table of an estimated queue line database;

FIG. 13 is a flowchart illustrating an estimated queue line planning process;

FIG. 14 is a flowchart illustrating a guidance content determination process;

FIG. 15 is an example of a screen of a queue guidance unit;

FIG. 16 is a flowchart illustrating a main trajectory detection process;

FIG. 17 is a flowchart illustrating a queue plan making process;

FIG. 18 is an example of a user interface screen provided by the population flow guidance system;

FIG. 19 is an example of a screen that edits obstacle data;

FIG. 20 is an example of a screen that edits a main trajectory;

FIG. 21 is an example of a screen that edits a queue condition;

FIG. 22 is an example of a screen that edits an estimated queue line; and

FIG. 23 is an example of a screen that edits a queue estimated number of people.

### DESCRIPTION OF EMBODIMENTS

Hereinafter, an embodiment of the present invention will be described based on the drawings. A population flow guidance system as “moving body queue management system” according to the embodiment plans an estimated queue line for guiding a moving body to a queue of moving bodies such that at least a part of the queue of the moving bodies crosses a main trajectory. As a result, for example, even during congestion, the population flow guidance system can manage a queue for receiving a service.

The population flow guidance system according to the embodiment can include: a trajectory DB configured to store trajectory data of the moving bodies; and an estimated queue line planning unit configured to change an interval or an extension direction of the queue of the moving bodies to plan a guidance position of the queue of the moving bodies based on the trajectory DB.

The population flow guidance system according to the embodiment includes a main trajectory detection unit configured to detect an area and a traveling direction of a main trajectory based on the trajectory DB, in which the estimated queue line planning unit changes the interval or the extension direction of the queue of the moving bodies to plan the guidance position of the queue of the moving bodies based on the traveling direction of the main trajectory in the area of the main trajectory.

The population flow guidance system according to the embodiment includes: a population flow prediction unit configured to predict a trajectory in a target area; and an estimated number-of-people calculation unit configured to calculate the number of people to be lined up on the queue based on predicted trajectory data, in which when the number of people calculated by the estimated number-of-people calculation unit does not fall within a planned queue line, the estimated queue line planning unit can re-plan a queue line.

In the population flow guidance system according to the embodiment, the estimated queue line planning unit changes the interval or the extension direction of the queue of the moving bodies to plan the guidance position of the queue of the moving bodies based on the predicted trajectory data using information on the main trajectory detected by the main trajectory detection unit.

The embodiment will be described using people as the moving bodies. However, the present invention is not limited to pedestrians and is applicable to a queue of bicycles, automobiles, or people using a means of transportation such as kick scooters. Further, as the moving bodies, for example, machines having an autonomous traveling function such as drones, automated guided vehicles, autonomous mobile robots, automobiles, construction machines, ships, or submarines are applicable.

The population flow guidance system according to the embodiment is applicable not only to queue management in an actual facility but also to queue management in a virtual space. Examples of the actual facility or the facility in the virtual space include a station, an airport, a commercial store, a stadium, or an exhibition hall.

### First Embodiment

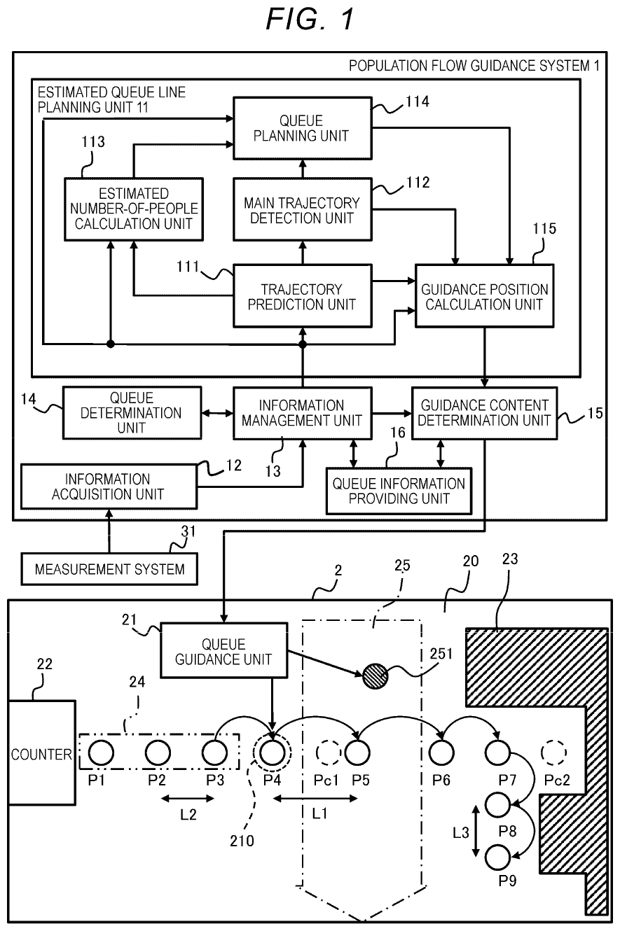

A first embodiment will be described using FIGS. 1 to 23. FIG. 1 is an overall schematic diagram illustrating a population flow guidance system 1 according to the embodiment. A configuration illustrated in FIG. 1 illustrates the summary of the population flow guidance system 1 to a degree that is required for understanding and implementing the embodiment, and the scope of the present disclosure is not limited to the configuration illustrated in the drawing. A part of the configuration illustrated in FIG. 1 may be omitted, or a new configuration that is not illustrated in the drawing may be added to the configuration illustrated in FIG. 1.

In a facility 2 such as a station, an airport, or a commercial store, a queue waiting for various services may extend and interfere with pedestrians during congestion. Examples of the services include sales of tickets, sales of admission tickets, deposit of luggage, shipping of luggage, sales of products, and provision of food and drink.

When a queue waiting for a service is long, a length of the queue also needs to be sufficiently ensured. When the number of people that can be lined up on the queue is less than the number of people that use the service, the well-organized queue cannot be maintained.

Accordingly, when the queue waiting for the service is long in the facility during congestion, an area 25 (main trajectory 25) having a large amount of foot traffic also needs to be utilized to organize the queue such that the queue does not interfere with a trajectory of a pedestrian 251 who does not relate to the service.

Accordingly, the population flow guidance system 1 according to the embodiment plans a queue line such that the queue line does not interfere with the pedestrian 251 while sufficiently securing the length of the queue, and guides a person to a position where the person is to be lined up using a queue guidance unit 21 installed in the facility 2.

When the queue line is planned, the queue line needs to be organized so as not to interfere with the trajectory particularly in the area 25 having a large amount of foot traffic. Accordingly, in the population flow guidance system 1 according to the embodiment, the main trajectory at a target time is detected based on trajectory data measured by a measurement system 31 such as a laser radar or a camera, and an estimated queue line is planned not to interfere with the trajectory, for example, by changing an extension direction or an interval L1 of the queue with respect to the main trajectory 25.

Here, the target time refers to the time at which the population flow guidance system 1, the measurement system 31, and the queue guidance unit 21 operate to guide a person as a guidance target. When the trajectory is divided by a predetermined time period or a passage area, the main trajectory refers to a group of divided trajectories where the number of trajectories per unit area is a given value or more. The division of the trajectory by the passage area may be performed, for example, based on a determination result obtained by dividing a target area in a grid shape and performing spatial crossing determination on the respective divided areas. Alternatively, the division may be performed using information on each of divided areas obtained by dividing a target area by a freely set group of boundaries. The estimated queue line represents an estimated queue line to which a person to be lined up on the queue is guided.

The facility 2 will be described. On a floor 20 of the facility 2, a counter 22 that provides the service is provided. The counter 22 can also be referred to as, for example, a service providing site. A person P1 who is positioned at a start position immediately before the counter 22 and candidates P2 and P3 who want to receive the service form a queue 24.

The queue guidance unit 21 guides a new user (user candidate) P4 to a waiting position, which is the next position of the end of the queue. As described below, the population flow guidance system 1 can plan the estimated queue line such that the estimated queue line crosses the main trajectory 25.

The queue guidance unit 21 instructs another new user to wait at a waiting position P5 in an area of the main trajectory 25. At this time, in the area of the main trajectory 25, the interval L1 of the queue is set to be longer than an interval L2 in an area other than the area of the main trajectory 25 (L1>L2). Accordingly, the other new user is guided to the waiting position P5 that is slightly in front of a waiting position Pc1 obtained from the original interval L1 of the queue.

In the population flow guidance system 1 according to the embodiment, by setting the interval L1 of the queue in a main trajectory area to be long, the path of the pedestrian 251 who crosses the main trajectory 25 is ensured. After the queue passes the main trajectory area, the queue interval may be returned to the original distance L2 from the distance L1 or may be set to still another distance L3.

As described above, the reference numerals P1 to P9 represent waiting positions of people (service users) to be lined up on the queue or service users. When an obstacle 23 (or a passage restriction area) is present in front of the end of the queue that crosses the main trajectory area such that the number of people that can be lined up until the end of the queue reaches the obstacle 23 is less than an estimated number of people of the queue, the queue cannot extend as it is.

Accordingly, in order to ensure the length of the queue, the population flow guidance system 1 changes the direction of the queue from a waiting position Pc2 to a waiting position P8. In this example, the direction is changed by about 90 degrees. However, the direction of the queue may be changed by an angle other than 90 degrees. The angle at which the queue crosses the main trajectory may be 90 degrees or may be a value other than 90 degrees. Further, the queue may cross the same main trajectory multiple times. For example, after crossing the main trajectory at a first angle at a first site, the queue can cross the main trajectory again at a second angle at a second site that is distant from the first site in the direction of the main trajectory. The first angle and the second angle may be the same value or different values.

Accordingly, the queue that is organized by the population flow guidance system 1 can be divided into a first queue area (P1 to P4) before interfering with the main trajectory area, a second queue area interfering with the main trajectory area, and a third queue area (P6 to P9) after passing through the main trajectory area, with the service providing site 22 at the start position. Further, the third queue area can also be divided into a direction non-change area (P6 and P7) before the change of the queue direction and a direction change area (P8 and P9) after the change of the queue direction. Although not illustrated in the drawing, when the queue further extends, the queue may penetrate another trajectory area, may pass another trajectory area, or may change the direction.

A configuration example of the population flow guidance system 1 will be described. The population flow guidance system 1 can include, for example, an estimated queue line planning unit 11, an information acquisition unit 12, an information management unit 13, a queue determination unit 14, a guidance content determination unit 15, and a queue information providing unit 16.

The information acquisition unit 12 acquires measurement data from the measurement system 31. The information management unit 13 manages the acquired information. The queue determination unit 14 determines whether the queue is formed. The guidance content determination unit 15 determines a guidance content including the guidance position (the position for guidance to the end of the queue) calculated by the estimated queue line planning unit 11, and transmits the determined guidance content to the queue guidance unit 21.

The queue information providing unit 16 provides information regarding the queue to a service provider of the service counter 22, a manager of the facility 2, or the like. Examples of the information regarding the queue include the start position of the queue, an end position of the queue, the number of people of the queue, and an extension rate of the queue (person/hour).

The estimated queue line planning unit 11 manages the queue formed on the floor 20 where the counter 22 as the service providing site is present, and calculates an instruction for organizing the queue. The estimated queue line planning unit 11 can also manage a plurality of queues on the same floor 20, and can also manage each of queues on a plurality of floors of the facility 2. Further, the population flow guidance system 1 can centrally manage a plurality of queues on a plurality of floors 20 of a plurality of facilities 2 that are geographically distributed.

The estimated queue line planning unit 11 includes, for example, a trajectory prediction unit 111, a main trajectory detection unit 112, an estimated number-of-people calculation unit 113, a queue planning unit 114, and a guidance position calculation unit 115.

The trajectory prediction unit 111 predicts the trajectory (population flow) on the floor 20 as the management target based on the information from the information management unit 13. The main trajectory detection unit 112 detects the main trajectory 25 based on the predicted trajectory. The estimated number-of-people calculation unit 113 calculates the length of the queue, that is, a maximum value of the number of people to be lined up on the queue.

The queue planning unit 114 plans the estimated queue line based on the maximum number of people of the queue and the main trajectory. The guidance position calculation unit 115 calculates positions to be lined up on the queue along the planned estimated queue line.

The population flow guidance system 1 receives the measurement data from the measurement system 31 and receives map data from a user of the population flow guidance system 1. The population flow guidance system 1 includes: a function 112 of detecting the main trajectory 25 in the target area (the floor 20 as the management target) using the trajectory data extracted from the measurement data; a function 113 of acquiring an estimated number of people to be lined up on the queue; a function 114 of planning the estimated queue line based on the main trajectory, the estimated number of people, the map data, and the like; and a function 115 of calculating the guidance information based on the estimated queue line, the trajectory data, the map data, and the main trajectory data. The calculated guidance information is transmitted to the queue guidance unit 21 and is displayed to the people to be lined up on the queue.

The guidance content determination unit 15 can provide the information, through the queue guidance unit 21, not only to the people (service users) to be lined up on the queue but also to the pedestrian 251 (another moving body) who does not relate to the service as causing the queue.

The guidance content determination unit 15 provides a first content to the people (service users) who directly relate to the queue, and provides a second content to the person (pedestrian) who does not directly relate to the queue. The first content includes, for example, a message “The people who use the service SA may line up at the guidance position. The current wait time is about 45 minutes.” and a map indicating the waiting position. A modification example of the first content provided to the service user who is waiting in the main trajectory area can include a message “The people who use the service SA may line up at the guidance position. Please take care not to interfere with the pedestrian. The current wait time is about 45 minutes.” and a map indicating the waiting position.

The second content can include, for example, a message “There is the queue of people who use the service SA in front of this site. Please take care.” and a map indicating the position of the queue. Here, for example, when a person who is waiting in the main trajectory area can be illuminated from the top, the color of the floor of the waiting position can be changed, or the waiting position can be illuminated with laser light so as to surround the waiting position, a message “The feet of the people who are waiting on the queue are illuminated with red light. Therefore, please take care.” may be added to the second content.

The first content or the second content may be individually transmitted to the service users (the people to be lined up on the queue) or the pedestrian, or may be collectively transmitted to a plurality of people present in a predetermined area on the floor 20. When the first content or the second content is individually transmitted, for example, a directional speaker that transmits a sound to only a specific range may be used, or a text message or a voice message may be delivered to a portable information terminal (for example, a wearable terminal or a smartphone) that is carried by the service user or the pedestrian. For example, when it is detected that the portable information terminal of the service user that previously receives numbered ticket data for using the service enters the facility 2, the first content can be transmitted to the portable information terminal.

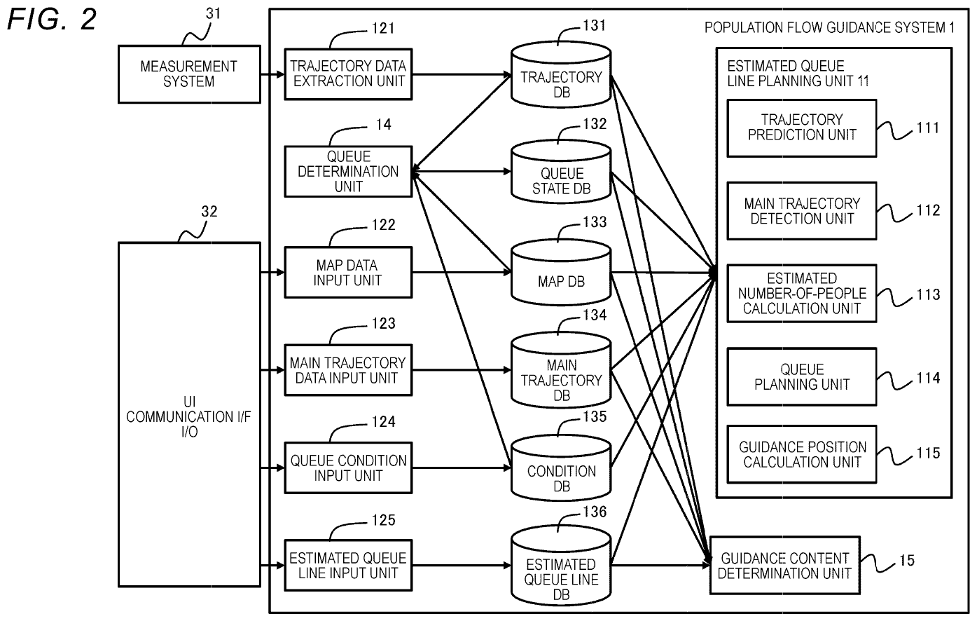

FIG. 2 is a functional block diagram illustrating the population flow guidance system 1. The population flow guidance system 1 includes the following functional blocks.

The population flow guidance system 1 includes, as the information acquisition unit 12, for example, a trajectory data extraction unit 121, a map data input unit 122, a main trajectory data input unit 123, a queue condition input unit 124, and an estimated queue line input unit 125.

The population flow guidance system 1 includes, as the information management unit 13, for example, a trajectory DB 131, a queue state DB 132, a map DB 133, a main trajectory DB 134, a condition DB 135, and an estimated queue line DB 136.

The trajectory data extraction unit 121 of the information acquisition unit 12 extracts the trajectory data based on sensor data received from the measurement system 31. The details will be described below.

For example, data is input to the other functions 122 to 125 of the information acquisition unit 12 from an input means 32 such as a user interface (in the drawing, UI), a communication interface (in the drawing, communication I/F), or an input/output port (in the drawing, I/O).

The user interface is connected to an information input/output device (not illustrated), and the user can input data to the population flow guidance system 1 using the information input/output device. Examples of the information input/output device include a monitor display, a keyboard, a pointing device such as a mouse, a touch panel, and a voice input device.

In addition, the user can input the data to each of the functions 122 to 125 by transferring the data stored in a storage device (not illustrated) to the population flow guidance system 1. The storage device (not illustrated) may be a storage device that is used in a server in a communication network, or may be a storage device such as a semiconductor memory that is directly connected to the population flow guidance system 1.

Each of the blocks will be described. Here, a case where a plurality of queues are processed in parallel will be described as an example. The plurality of queues to be processed may be present on the same floor or may be present on different floors. The plurality of queues to be processed may be present in different facilities. In this case, the measurement system 31 or the like is prepared for each facility.

When the data measured by the measurement system 31 is received, the trajectory data extraction unit 121 has a function of extracting the trajectory data from the received data and storing the trajectory data in the trajectory DB 131. At this time, the data measured by the measurement system 31 may be moving image data of the target area or may be laser radar data. When the trajectory data is extracted from the moving image data, a person may be recognized by an image processing technique to extract coordinates of the person. When the trajectory data is extracted from the laser radar data, a moving body of which the distance from the laser radar changes may be extracted as a person to transform the extracted moving body into coordinate information.

The queue determination unit 14 determines when, on which queue, and in what order each person (service user) is lined up based on the trajectory data, the map data, or the start point data of the queue. For example, when the trajectory data of the trajectory DB 131 is updated or whenever a given period of time elapses, the queue determination unit 14 has a function of determining when, on which queue, and in what order each person is lined up using the trajectory data of the trajectory DB 131, obstacle data of the map DB 133, and queue line definition condition data of the condition DB 135, and storing the determination result in the queue state DB 132.

The map data input unit 122 has a function of receiving, from the user, data representing a position and a shape of an area where an obstacle is present and a person cannot pass through and data representing a position and a shape of an area where passage is restricted in the target area, and storing the data in the map DB 133. The data may be manually input by the user and may be input as a file.

The main trajectory data input unit 123 has a function of receiving data representing a position or a shape, a traveling direction, and a formation time period of the main trajectory in the target area from the user and storing the data in the main trajectory DB 134.

The queue condition input unit 124 has a function of receiving data representing the start position of the queue and data representing a direction (initial direction) in which the queue extends from the start position from the user and storing the data in the condition DB 135.

The estimated queue line input unit 125 has a function of receiving data representing a position and a shape of the estimated queue line from the user and storing the data in the estimated queue line DB 136.

When the trajectory data stored in the trajectory DB 131, the queue state data stored in the queue state DB 132, the obstacle data and the passage restriction area data stored in the map DB 133, and the queue line definition condition data stored in the condition DB 135 are received, the estimated queue line planning unit 11 executes a population flow simulation or the like to predict the trajectory.

The estimated queue line planning unit 11 extracts the main trajectory based on the measured trajectory data and the predicted trajectory data, and stores the extracted main trajectory data in the main trajectory DB 134. The estimated queue line planning unit 11 acquires data regarding a method of adjusting the guidance position of the person to be lined up on the queue with respect to the main trajectory using the detected main trajectory data, the queue state data stored in the queue state DB 132, and the trajectory data stored in the trajectory DB 131, and transmits the acquired data to the guidance content determination unit 15.

The estimated queue line planning unit 11 acquires a maximum number of people to be lined up on each queue based on the predicted trajectory data, calculates an estimated person capacity of each queue based on the acquired maximum number of people, and stores the data regarding the calculated estimated person capacity in the condition DB 135.

The estimated queue line planning unit 11 has a function of defining the estimated queue line of each queue using the calculated estimated person capacity data of each queue, the detected main trajectory data, the trajectory data stored in the trajectory DB 131, the queue state data stored in the queue state DB 132, the obstacle data and the passage restriction area data stored in the map DB 133, the estimated queue line definition condition data stored in the condition DB 135, and the correction data of the queue guidance position, and storing the defined estimated queue line in the estimated queue line DB 136.

In order to implement the above-described functions, the estimated queue line planning unit 11 includes, for example, the trajectory prediction unit 111, the main trajectory detection unit 112, the estimated number-of-people calculation unit 113, the queue planning unit 114, and the guidance position calculation unit 115. The details of each unit will be described below.

The guidance content determination unit 15 receives the trajectory data stored in the trajectory DB 131, the queue state data stored in the queue state DB 132, the estimated queue line data stored in the estimated queue line DB 136, and the correction data of the queue guidance position transmitted from the estimated queue line planning unit 11.

The guidance content determination unit 15 determines which position on the estimated queue line corresponds to the end of the actual queue based on the trajectory data and the queue state data, and determines the guidance position of the next person to be lined up on each queue on the estimated queue line based on the determination result.

The guidance content determination unit 15 calculates the guidance position of the queue at an overlapping portion where the main trajectory area and the estimated queue line overlap each other based on the trajectory data, the queue state data, and the correction data of the queue guidance position. As described above, in the area where the estimated queue line overlaps the main trajectory area, the interval between adjacent service users needs to be widened such that the queue does not interfere with the passage of a pedestrian that is not the service user. The guidance content determination unit 15 transmits the calculated guidance position to the queue guidance unit 21.

The data stored in the trajectory DB 131, the queue state DB 132, the map DB 133, the main trajectory DB 134, the condition DB 135, and the estimated queue line DB 136 will be described below.

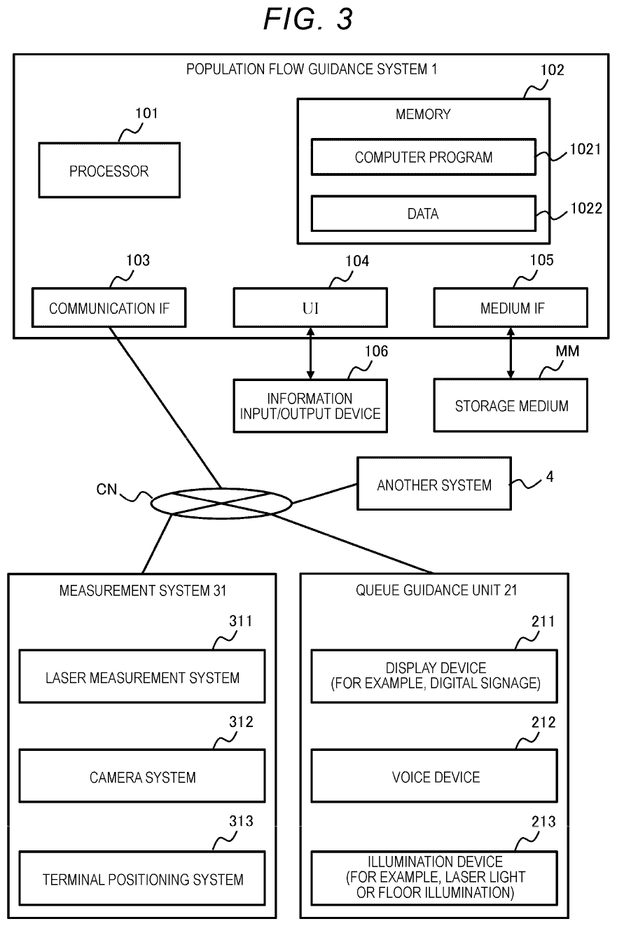

FIG. 3 is a diagram illustrating a hardware configuration diagram of an overall system including the population flow guidance system 1. The population flow guidance system 1 is configured as a computer including, for example, a processor 101, a memory 102, a communication interface 103, a user interface 104, and a medium interface 105.

The memory 102 includes a main storage device and an auxiliary storage device. The memory 102 stores a computer program 1021 and data 1022. The processor 101 implements each function as the population flow guidance system 1 by reading and executing the computer program 1021 stored in the memory 102. The processor 101 is not limited to a microprocessor and may include a graphics processing unit (GPC) or a dedicated circuit.

The communication interface 103 is connected to the queue guidance unit 21, the measurement system 31, and another system 4 through a communication network CN. Examples of the other system 4 include a computer that is used by the provider of the service causing the queue and a computer that manages the safety of the facility 2.

The user interface 104 is connected to an information input/output device 106. Examples of the information input/output device 106 include a monitor display, a keyboard, a mouse, and a touch panel. The medium interface 105 is connected to a storage medium MM. Examples of the storage medium MM include a semiconductor memory, a hard disk, and an optical disk. At least a part of the computer program 1021 and the data 1022 of the population flow guidance system 1 can be transferred to and stored in the storage medium MM. Conversely, at least a part of the computer program and the data stored in the storage medium MM can be transferred to and stored in the memory 102 of the population flow guidance system 1.

The queue guidance unit 21 includes, for example, at least one information transmission device such as a display device 211, a voice device 212, or an illumination device 213. For example, as known as a so-called digital signage, the display device 211 is a large-sized monitor display having a communication function, and is installed on a wall, a pillar, or the like in the facility 2. The voice device 212 is configured as a speaker system. When a person in the facility 2 wears communicable earphones, the earphones can also be used as the voice device 212. Examples of the illumination device 213 include a ceiling illumination device, a floor illumination device, and a wall illumination device. The service user can be guided to a wait position by illuminating the wait position with laser light or by changing the color of a floor corresponding to the wait position. The display device 211, the voice device 212, and the illumination device 213 can also be used in combination.

As the queue guidance unit 21, a portable information terminal that is carried by the service user or the pedestrian in the facility 2 may be used. The guidance information determined by the population flow guidance system 1 may be transmitted to the portable information terminal as an e-mail or a short message. A communication function or a display function can also be given to an admission ticket of the facility 2 such that the guidance information from the population flow guidance system 1 can be distributed through a near field communication network provided in the facility 2.

The measurement system 31 measures movement of a person in the facility 2 and transmits measurement data thereof to the population flow guidance system 1. The measurement system 31 includes, for example, at least one of a laser measurement system 311, a camera system 312, and a terminal positioning system 313. The laser measurement system 311 detects a position and movement of a person in the facility 2 using a laser radar. The camera system 312 images the inside of the facility 2 and detects a person from the obtained image data. The terminal positioning system 313 is configured as a portable information terminal carried by a person in the facility 2 and specifies a position or the like of the person who carries the terminal. These systems 311 to 313 may be used in combination.

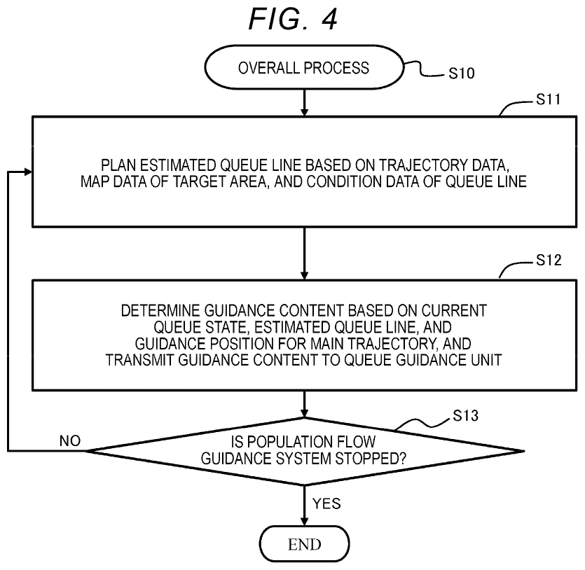

A flowchart of FIG. 4 illustrates an overall process that is executed by the population flow guidance system 1. Hereinafter, a reference numeral (here, S10) that is given to the start step of a process represents the start of the process. However, the overall process illustrated in the drawing may be represented by the start reference numeral.

The population flow guidance system 1 calculates a main trajectory at a target time and an estimated number of people to be lined up on the queue based on the trajectory data, the map data, and the condition data of the queue line, and defines the estimated queue line at the target time using the calculated result or the like (S11). Step S11 is mainly executed by the estimated queue line planning unit 11 as follows.

The estimated queue line planning unit 11 predicts the trajectory at the target time, for example, using the trajectory data stored in the trajectory DB 131 and the obstacle data stored in the map DB 133. The population flow guidance system 1 detects the main trajectory in the target area together with the time at which the main trajectory is formed based on the measured trajectory data and the predicted trajectory data, and stores the detected main trajectory data in the main trajectory DB 134.

The estimated queue line planning unit 11 calculates data regarding a method of adjusting the guidance position of the person to be lined up on the queue with respect to the main trajectory using the detected main trajectory data, the queue state data stored in the queue state DB 132, and the trajectory data stored in the trajectory DB 131, and transmits the calculated data to the guidance content determination unit 15.

The estimated queue line planning unit 11 calculates a maximum number of people to be lined up on each queue in the target area at the target time based on the predicted trajectory data at the target time, and stores an estimated person capacity that is acquired based on the calculated maximum number of people in a queue estimated number-of-people table of the condition DB 135 together with a start time and an end time in each time period.

The estimated queue line planning unit 11 defines the estimated queue line at the target time on a predetermined time period basis using the main trajectory data, the data of the estimated person capacity of each queue, the trajectory data stored in the trajectory DB 131, the queue state data stored in the queue state DB 132, the obstacle data and the passage restriction area data stored in the map DB 133, and the queue line definition condition data stored in the condition DB 135. The estimated queue line planning unit 11 stores the data regarding the defined estimated queue line in the estimated queue line DB 136 together with the start time and the end time in each time period. The details of Step S11 will be further described.

Step S12 is executed by the guidance content determination unit 15 as follows. The guidance content determination unit 15 determines a guidance content based on the current queue state, the estimated queue line, and the guidance position adjustment information with respect to the main trajectory, and transmits the determined guidance information to the queue guidance unit 21.

The guidance content determination unit 15 detects a guidance position corresponding to the current end among estimated guidance positions on the estimated queue line, for example, using the trajectory data of the trajectory DB 131, the queue state data of the queue state DB 132, and the estimated queue line data of the estimated queue line DB 136.

The estimated guidance position is an estimated position to which a person (service user) to be lined up on the queue is guided. The guidance content determination unit 15 extracts the position at which the next person to be lined up on the queue is to be lined up using the data regarding the end on the detected estimated queue line and the estimated queue line data of the estimated queue line DB 136.

The guidance content determination unit 15 determines a position to which the next service user to be lined up on the queue is guided on the queue in the main trajectory area based on the correction data of the queue guidance position transmitted from the estimated queue line planning unit 11.

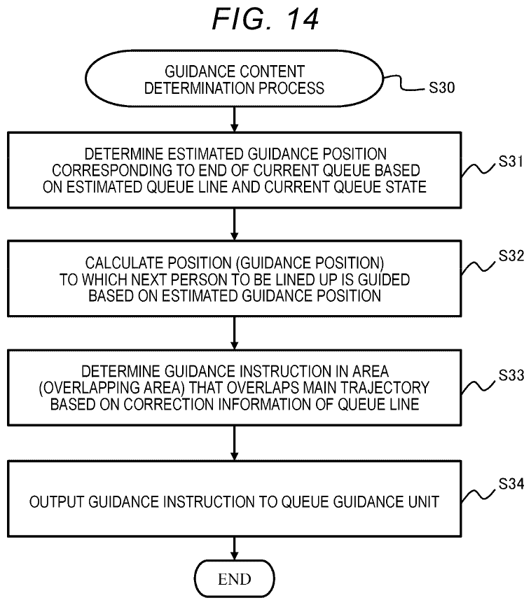

The guidance content determination unit 15 transmits the trajectory data of the trajectory DB 131, the queue state data of the queue state DB 132, the map data group of the map DB 133, the main trajectory data of the main trajectory DB 134, and data regarding guidance contents acquired in Steps S32 and S33 described below with reference to FIG. 14 to the queue guidance unit 21, and displays the data on the queue guidance unit 21. The details of Step S12 will be further described.

The population flow guidance system 1 determines whether a preset operation end condition is satisfied (S13). When the operation end condition is not satisfied (S13: NO), the population flow guidance system 1 returns to Step S11. When the operation end condition is satisfied (S13: YES), the population flow guidance system 1 ends the present process.

The operation end condition may be determined based on a preset operation schedule of the population flow guidance system 1, and a power switch of the population flow guidance system 1 may be turned off by a user such as a system manager to end the operation. When the user inputs an end command from the information input/output device 106 to the population flow guidance system 1, the population flow guidance system 1 may end the operation. The operation end condition is not limited to the above-described content.

The population flow guidance system 1 can operate a part of the functions at all times to automatically execute whether to operate or end. For example, in the population flow guidance system 1, an operation determination unit monitors at all times whether a queue (queue for the operation determination) of people to be guided to the target area and to be organized is formed. When the formation of the queue is detected by the operation determination unit, the remaining portion of the population flow guidance system 1 is operated. When the operation determination unit determines that the queue for the operation determination is not formed, functions other than the operation determination unit in the population flow guidance system 1 are stopped. The operation determination unit can be configured to include, for example, the information acquisition unit 12, the information management unit 13, and the queue determination unit 14. The other functions include, for example, the estimated queue line planning unit 11, the guidance content determination unit 15, and the queue information providing unit 16.

The information acquisition unit 12 can also be used as the operation determination unit. For example, when the information acquisition unit 12 detects the presence of a predetermined number of people within a predetermined period of time, the information acquisition unit 12 may start the other functions 11, 13, 14, 15, and 16.

The operation and the end of the population flow guidance system 1 can also be automatically controlled in multiple stages. For example, when the information acquisition unit 12 that operates at all times detects the presence of a predetermined number of people within a predetermined period of time, the information acquisition unit 12 starts the information management unit 13 and the queue determination unit 14 to determine whether the predetermined number of people is the queue for the operation determination, and when the information acquisition unit 12 determines that the predetermined number of people is the queue for the operation determination, the information acquisition unit 12 may start the remaining functions 11, 15, and 16.

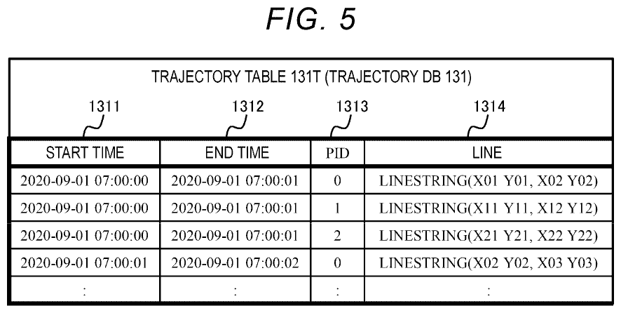

FIG. 5 is an example of a trajectory table 131T stored in the trajectory DB 131. The data stored in the trajectory table 131T of the trajectory DB 131 may be trajectory data that is extracted from the data measured by the measurement system 31 in the target facility, or may be trajectory data that is acquired in advance in a predetermined area.

The trajectory table 131T stores the trajectory data. The trajectory table 131T stores coordinates and the like of trajectory data that is sampled for each person or on a given period of time basis (for example, every second).

A start time 1311 is the time at which the sampling of the trajectory data starts. An end time 1312 is the time at which the sampling of the trajectory data ends. A PID 1313 is information that identifies a person. A line 1314 is trajectory data that is sampled. The data stored in the line 1314 may be geometry data such as LINESTRING, or may be coordinate values at the start time and the end time of the sampling. In addition, the coordinate system may be any coordinate system, for example, a Cartesian coordinate system.

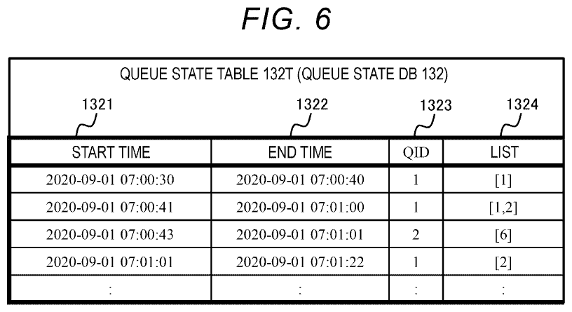

FIG. 6 is an example of a queue state table 132T stored in the queue state DB 132. The data stored in the queue state DB 132 may be data prepared in advance or may be data transmitted from the queue determination unit 14.

The queue state table 132T stores data representing when, on which queue, and in what order each person is lined up. A start time 1321 represents the time at which a time period when the corresponding queue state is formed starts. An end time 1322 represents the time at which a time period when the corresponding queue state is formed ends. A QID 1323 is information that identifies a queue.

The QID 1323 corresponds to a QID 1351 of a queue line definition condition table 135T1 stored in the condition DB 135. A list 1324 is data regarding which PID 1313 people are lined up in what order on the queue designated by the QID 1323 in the period between the start time 1321 and the end time 1322. For example, in the list 1324, the data is displayed in the form of a sequence. Each element in the sequence corresponds to the PID 1313, and the order of the element corresponds to the order of the person to be lined up on the queue.

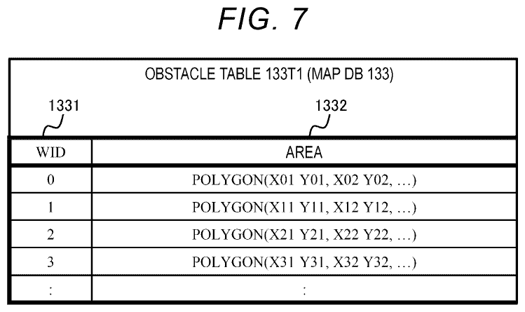

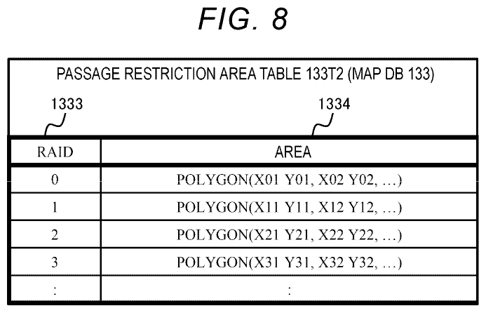

FIG. 7 illustrates an obstacle table 133T1 stored in the map DB 133. The data stored in the map DB 133 may be data prepared in advance or may be data input by the user with the map data input unit 122. The same can be applied to a passage restriction area table 133T2 described below with reference to FIG. 8.

The obstacle table 133T1 stores data representing a position and a shape of an object such as a wall or an object through which a person cannot pass. A WID 1331 is information that identifies the object. An area 1332 represents information regarding the position and the shape of the object. In the area 1332, coordinates representing the object shape are represented as geometry data such as POLYGON or LINESTRING. As in the line 1314, any coordinate system can be used.

FIG. 8 illustrates the passage restriction area table 133T2 stored in the map DB 133. The passage restriction area table 133T2 stores data representing a position and a shape of an area where the passage of people is desired to be restricted. In the passage restriction area, the extension of a queue is restricted irrespective of the formation of a main trajectory.

For example, in a case where an advertisement is displayed by a digital signage, when a queue is formed in front of the digital signage, the advertisement is inconspicuous from pedestrians. By setting an area where the digital signage is installed as the passage restriction area, congestion in front of the digital signage can be relieved.

A RAID 1333 is information that identifies the passage restriction area. In an area 1334, coordinates representing the position and the shape of the passage restriction area are represented as geometry data such as POLYGON. As in the line 1314, any coordinate system can be used.

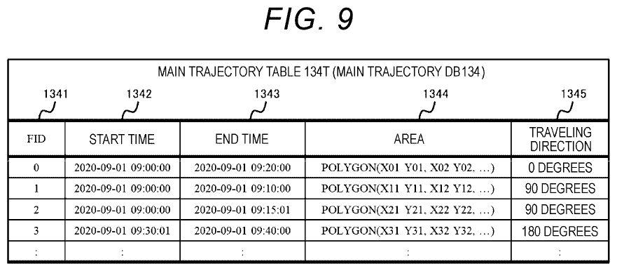

FIG. 9 is a main trajectory table 134T stored in the main trajectory DB 134. The main trajectory table 134T stores output data of the main trajectory detection unit 112, data input by the user with the main trajectory data input unit 123, or data prepared in advance.

The main trajectory table 134T stores data regarding a time, an area, and a main movement direction of the main trajectory in the trajectory data at the predicted target time. A FID 1341 is information that identifies the main trajectory. A start time 1342 and an end time 1343 represent the start time and the end time of the formation of the main trajectory. In an area 1344, an area where the main trajectory is present is represented as geometry data such as POLYGON. As in the line 1314, any coordinate system can be used. A traveling direction 1345 represents a representative value of the traveling direction of each trajectory in the main trajectory. For example, the representative value of the traveling direction may be an average value, a median value, or a mode of traveling directions of the trajectories in the corresponding group of divided trajectories or may be an average value of a minimum value and a maximum value in a range of the traveling direction.

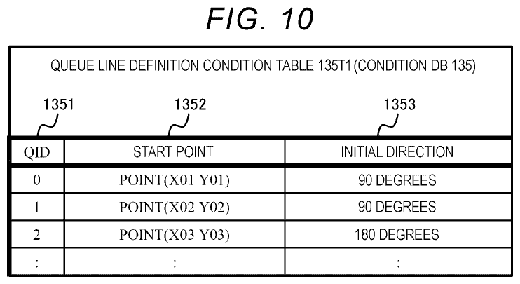

FIG. 10 is a queue line definition condition table 135T1 stored in the condition DB 135. The condition DB 135 stores data input by the user with the queue condition input unit 124 or data prepared in advance.

The queue line definition condition table 135T1 stores information regarding a start position of a queue and information regarding a direction (initial direction) in which the queue extends from the start position. A QID 1351 is information that identifies a queue. A start point 1352 represents coordinates representing the start position of each queue as geometry data such as POINT. In the start point 1352, any coordinate system can be used as in the line 1314. An initial direction 1353 represents a direction in which the queue extends from the start position of the queue when the next estimated guidance position is determined.

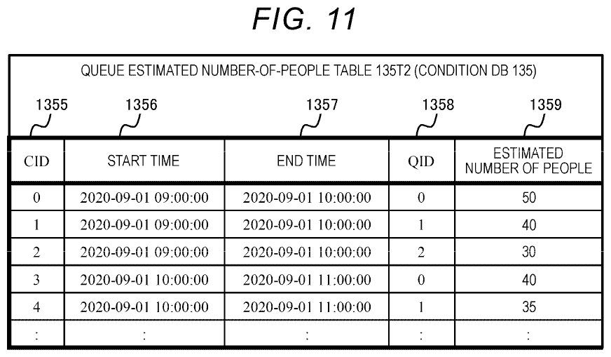

FIG. 11 is a queue estimated number-of-people table 135T2 stored in the condition DB 135. The queue estimated number-of-people table 135T2 stores data regarding the estimated person capacity of each of the estimated queue lines in each time period at the target time. A CID 1355 is information that identifies a data group regarding an estimated number of people, a queue thereof, and a time period thereof. A start time 1356 and an end time 1357 represent the start time and the end time of each time period. A QID 1358 is information that identifies a queue and corresponds to the QID 1351 of the queue line definition condition table 135T1. An estimated number of people 1359 represents the estimated person capacity of the estimated queue line represented by the QID 1358 in the period from the start time to the end time.

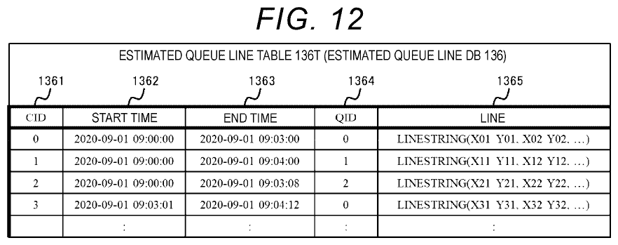

FIG. 12 illustrates an estimated queue line table 136T stored in the estimated queue line DB 136. The estimated queue line DB 136 stores output data of the queue planning unit 114, data input by the user with the estimated queue line input unit 125, or data prepared in advance.

The estimated queue line table 136T stores data representing a time, a shape, and a queue of a planned estimated queue line. A CID 1361 is information that identifies an estimated queue line. A start time 1362 and an end time 1363 represent the start time and the end time of a time period in which the corresponding estimated queue line is used for guidance. A QID 1364 is information that identifies the corresponding queue and corresponds to the QID 1351. In a line 1365, coordinates representing the object shape are represented as geometry data such as LINESTRING.

Here, LINESTRING representing the line may be configured with a sequence of points representing the estimated guidance position on the estimated queue line. As a result, when the guidance content determination unit 15 determines the guidance position of a person to be lined up on the queue based on the data regarding the estimated queue line, the coordinate data of the sequence of points can be directly used. Alternatively, the determination may be as follows.

For example, when the estimated queue line is one straight line, in order to record this shape information, only coordinate data of a start point and coordinate data of an end point in the straight line are needed, and it is assumed that only these pieces of data are stored in the line. In this case, a site on the estimated queue line that is at a predetermined distance in a predetermined direction from the position of the end of the actual queue line detected based on the trajectory data may be determined as the guidance position.

Alternatively, the guidance positions that are already guided may be sequentially recorded such that a position on the estimated queue line that is at a predetermined distance in a predetermined direction from the guidance position may be set as the next guidance position. For example, in a state where one person is lined up on the estimated queue line, the next person to be lined up on the queue is guided to a site on the estimated queue line that is at a predetermined queue interval from the start position of the queue, and the guidance position is recorded even after completion of the guidance. The next person to be lined up on the queue may be guided as the guidance position to a site on the estimated queue line that is at a predetermined queue interval from the previously recorded guidance position.

Alternatively, as the data stored in the line, geometry data such as POINT may be stored as [POINT(X01 Y01), POINT(X02 Y02), . . . ] in the form of a sequence. In this case, each element in the sequence corresponds to coordinate data of the estimated guidance position, and the data may be stored such that the order of the element corresponds to the order of the estimated guidance position on the estimated queue line. Even in this case, when the guidance content determination unit 15 determines the guidance position of a person to be lined up on the queue based on the data of the estimated queue line, the coordinate data of each element in the sequence can be directly used. In the line 1365, any coordinate system can be used as in the line 1314.

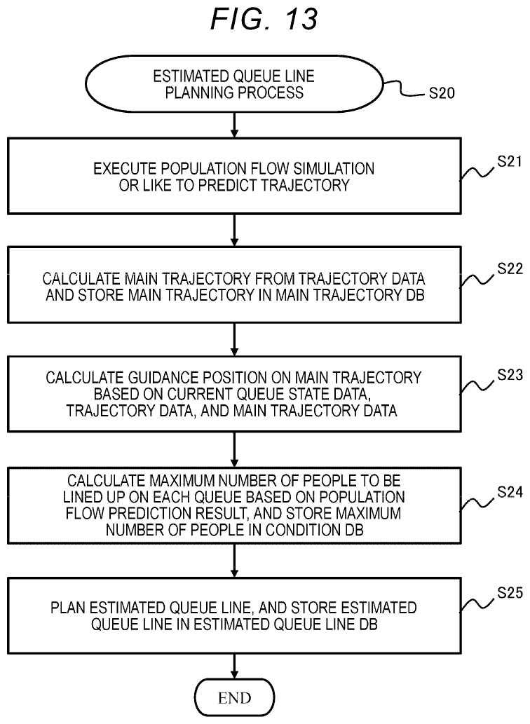

An estimated queue line planning process S20 that is executed by the estimated queue line planning unit 11 will be described using a flowchart of FIG. 13.

The trajectory prediction unit 111 of the estimated queue line planning unit 11 predicts the trajectory at the target time, for example, using the trajectory data stored in the trajectory DB 131 and the obstacle data stored in the map DB 133 (S21). The trajectory prediction unit 111 transmits the predicted trajectory data to the main trajectory detection unit 112 and the estimated number-of-people calculation unit 113 (S21).

The generated trajectory data includes information on each column in the trajectory data of the trajectory DB 131. At this time, as a method of a trajectory simulation, a simulation method based on a physical model such as Social Force Model may be used. The simulation may be performed by applying a movement model of a person that is learned by machine learning, for example, Support Vector Regression, Deep Learning, or Gradient Boosting.

When the machine learning is used, the current velocity vector, the distance from a surrounding obstacle in various directions, and a grid around the person may be extracted, feature data regarding the grid may be calculated, a movement model that predicts a velocity vector one step ahead may be learned, and the velocities may be sequentially predicted to perform the trajectory simulation. Alternatively, previous trajectory data earlier than the target time may be used as the trajectory prediction result of the target time. For example, when the trajectory in each time period of the morning, the day, and the night does not largely vary daily, data on a day different from the target time may be considered to be used as the trajectory prediction result of the target time as it is. Alternatively, information corresponding to the trajectory data of the trajectory DB 131 may be input by the user to use the input trajectory data as the trajectory prediction result.

The main trajectory detection unit 112 of the estimated queue line planning unit 11 detects the main trajectory using the current trajectory data stored in the trajectory DB 131 and the subsequent trajectory data predicted in Step S21 (S22). The main trajectory detection unit 112 stores the main trajectory data detected from the current trajectory data in the main trajectory DB 134 (S22). The main trajectory detection unit 112 transmits the main trajectory data to the queue planning unit 114. The details of Step S22 will be further described.

The guidance position calculation unit 115 of the estimated queue line planning unit 11 detects an overlapping area where the queue line of people that are already lined up at the current time overlaps the main trajectory area, for example, using the main trajectory data detected in Step S22, the queue state data stored in the queue state DB 132, and the trajectory data stored in the trajectory DB 131 (S23).

The guidance position calculation unit 115 determines whether an extension direction of the queue line in the detected overlapping area and a traveling direction of the main trajectory are orthogonal or parallel to each other (S23). When the guidance position calculation unit 115 determines that the extension direction of the queue line and the traveling direction of the main trajectory are orthogonal to each other, the guidance position calculation unit 115 adjusts the interval L1 of the estimated guidance position of the estimated queue line in the overlapping area (S23). The guidance position calculation unit 115 calculates queue adjustment data such that the interval L1 of the estimated guidance position is widened by any distance and such that the number of estimated guidance positions is reduced according to the widened distance (S23). The guidance position calculation unit 115 transmits the queue adjustment data regarding the decrease in the number of people on the queue in the overlapping area as a result of the adjustment to the queue planning unit 114 (S23).

The estimated number-of-people calculation unit 113 of the estimated queue line planning unit 11 calculates a maximum number of people to be lined up on each queue in a predetermined time period, for example, using the trajectory data predicted in Step S21 (S24). The estimated number-of-people calculation unit 113 acquires an estimated person capacity of each of the estimated queue lines based on the calculated maximum number of people, and stores the acquired estimated person capacity in the queue estimated number-of-people table of the condition DB 135 together with the start time and the end time of each time period (S24).

The estimated person capacity may be a maximum predicted number of people or may be a value obtained by multiplying the maximum predicted number of people by any constant value of 1 or more. The latter case corresponds to a case where the queue person capacity is set with a margin with respect to the trajectory prediction result.

The queue planning unit 114 of the estimated queue line planning unit 11 plans the estimated queue line, and stores the planned estimated queue line in the estimated queue line DB 136 (S25). The queue planning unit 114 defines the estimated queue line at the target time, for example, using the queue state data stored in the queue state DB 132, the obstacle data and the passage restriction area data stored in the map DB 133, the estimated queue line definition condition data stored in the condition DB 135, the main trajectory data detected in Step S22, the queue adjustment data calculated in Step S23, and the estimated number of people data calculated in Step S24 (S25). The queue planning unit 114 stores the data regarding the defined estimated queue line in the estimated queue line DB 136 (S25). The details of Step S25 will be further described.

A guidance content determination process S30 that is executed by the guidance content determination unit 15 will be described using a flowchart of FIG. 14.

The guidance content determination unit 15 determines the estimated guidance position corresponding to the end of the current queue based on the current queue state and the estimated queue line (S31). The guidance content determination unit 15 determines which estimated guidance position on the estimated queue line corresponds to the end of the current queue, for example, using the trajectory data of the trajectory DB 131, the queue state data of the queue state DB 132, and the estimated queue line data of the estimated queue line DB 136 (S31).

The guidance content determination unit 15 first detects coordinate data of a person at the end of each queue at the current time based on the queue state data and the trajectory data, compares the detected coordinate data with coordinate data of the estimated guidance position of the estimated queue line, and determines the estimated guidance position on each queue at which a person is already lined up.

Here, the guidance content determination unit 15 may extract the estimated guidance position closest to the position of the person at the end to perform the determination based on the extraction result. Alternatively, the guidance content determination unit 15 may acquire the number of elements of the list 1324 of the queue state data (the number of people to be lined up on the queue) such that an estimated guidance position that is positioned after the start position of the estimated queue line by the number of elements may be determined as the estimated guidance position corresponding to the end of the current queue. For example, when the number of elements in the list 1324 is “3” (that is, when the number of people to be lined up on the queue is three), the third estimated guidance position from the start position on the estimated queue line corresponds to the end of the current queue.

The guidance content determination unit 15 extracts coordinate data of the next estimated guidance position on the estimated queue line from the estimated guidance position corresponding to the end of the current queue that is determined in Step S31 (S32). The extracted coordinate data corresponds to position data of the next person to be lined up on the queue.

The guidance content determination unit 15 determines an additional guidance process based on the adjustment data of the queue on the main trajectory transmitted from the guidance position calculation unit 115 (S33). The guidance content determination unit 15 determines a content of guidance instruction such that the number of people in the queue area on the main trajectory (in the main trajectory area) is reduced (S33). The guidance instruction can include, for example, the next instruction.

First, in order for people not to flow into the overlapping area where the main trajectory area and the estimated queue line overlap each other, the guidance content determination unit 15 instructs a person to be lined up after the area to temporarily stop. Next, in order to reduce the number of people in the area and to widen the interval, the guidance content determination unit 15 instructs only a person at the start position in the area to come out of the area and to go forward when the queue advances, and instructs the other people in the area to be lined up at intervals in the area.

The guidance content determination unit 15 transmits the trajectory data of the trajectory DB 131, the queue state data of the queue state DB 132, the map data group of the map DB 133, the main trajectory data of the main trajectory DB 134, and the guidance information determined in Steps S32 and S34 to the queue guidance unit 21, and displays the transmitted information on the queue guidance unit 21 (S34).

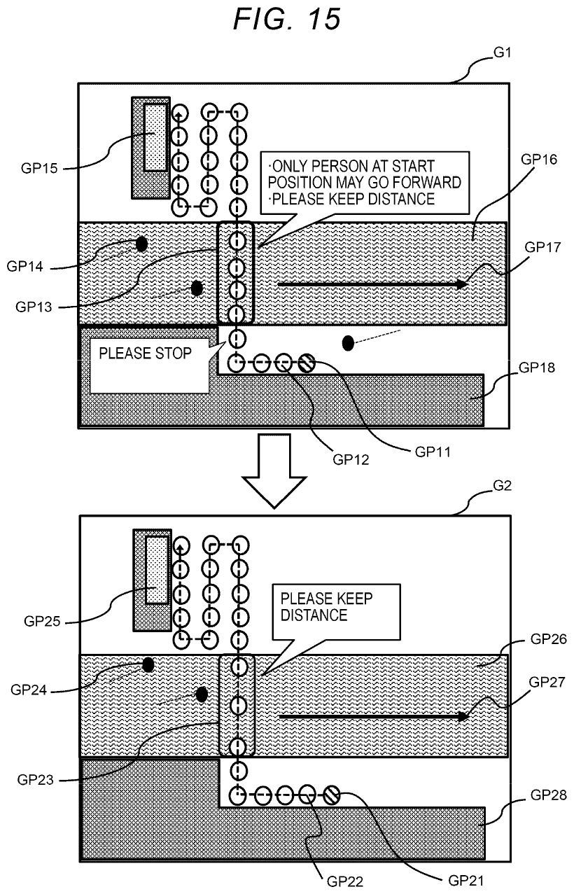

Examples of screens G1 and G2 displayed on the queue guidance unit 21 will be described using FIG. 15. Here, a digital signage or the like is assumed as the queue guidance unit 21.

The screen G1 illustrated on the upper side of FIG. 15 illustrates a display screen at time T1. The screen G2 illustrated on the lower side of FIG. 15 illustrates a display screen at time T2 after a predetermined period of time (for example, after 1 second) from time T1.

Display elements GP11 and GP21 represent the guidance position of the next person to be lined up on each queue determined in Step S32. The display elements GP12 and GP22 represent the positions where it is determined that people are already lined up at the time among the estimated guidance positions on the estimated queue line.

Based on the determination result (S31) of the estimated guidance position corresponding to the end of the queue, it may be determined that people are already lined up at all of the estimated guidance positions from the start to the end of the queue, and this determination result may be used. Based on the data of the queue state table and the data of the trajectory table instead of the data of the estimated queue line table, actual position data of a person to be lined up on the queue may be calculated and displayed instead of the estimated guidance position data, or both the actual position data and the estimated guidance position data may be displayed.

Display elements GP13 and GP23 represent queue areas that overlap main trajectory areas GP16 and GP26.

Display elements GP14 and GP24 represent population flows that are moving without being lined up on the queue at the time based on the trajectory data.

Display elements GP15 and GP25 represent the counter 22 that provides the service.

The display elements GP16 and GP17 represent the areas of the main trajectories detected at the time based on the main trajectory data. Display elements GP17 and GP27 represent traveling directions of the areas GP16 and GP26 of the detected main trajectories.

Display elements GP18 and GP28 represent position and shape data of obstacles.

Hereinafter, statuses displayed on the screens G1 and G2 will be supplemented. It is assumed that a person is lined up at the guidance position GP11 in a period from time T1 corresponding to the screen G1 to time T2 corresponding to the screen G2. This is determined by the queue determination unit 14 and is reflected in the data of the queue state DB 132. As a result, the position of the next person to be lined up on the queue is determined to be in a state where the person is already lined up, and the display is changed.

By updating the position of the end of the queue, the position of the next person to be lined up on the queue is also updated to the GP21 and displayed. The queue interval in the area GP23 where the main trajectory area and the estimated queue line overlap each other is set to be wider than the queue interval in the overlapping area GP13 on the screen G1.

The overlapping area GP13 is a queue that is formed on the main trajectory, and in order to widen the interval of the queue in the area to any set interval, for example, the message “Only the person at the start position may go forward. Please keep distance” is displayed such that only the person at the start position in the area goes forward and keeps distance from the other people. Further, for a person lined up immediately after the area GP13, for example, the message “Please stop” is displayed to prevent the person from flowing into the area.

When the time elapses from time T1 to time T2, in order to reduce the number of people in the queue area GP23 on the main trajectory by a predetermined number, the instruction to control the inflow and outflow of the overlapping area disappears from the digital signage. In this case, only the instruction to widen the queue interval in the area is displayed on the digital signage.

This way, depending on the number of people waiting in the overlapping area, the content displayed on the queue guidance unit 21 varies between the start and the end of the queue in the overlapping areas GP13 and GP23. A digital signage on the start side of the queue and a digital signage on the end side of the queue may be separated, and a common digital signage may be used. As described above, the queue guidance unit 21 is not limited to the digital signage.

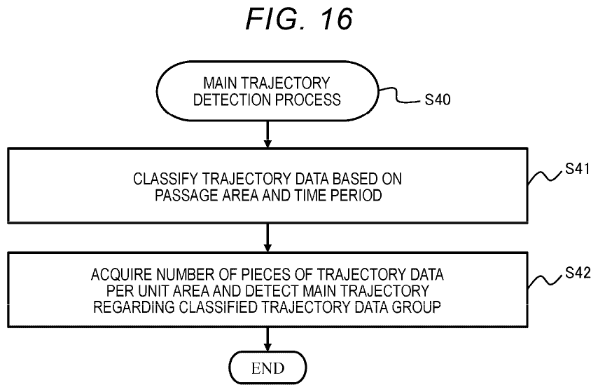

A main trajectory detection process S40 that is executed by the main trajectory detection unit 112 will be described using a flowchart of FIG. 16.

The main trajectory detection unit 112 classifies the trajectory data stored in the trajectory DB 131 and the trajectory data received from a population flow prediction unit 1131 based on the passage area of the trajectory, the angle of the traveling direction thereof, and the time period where the trajectory is formed (S41).

The detection of the main trajectory is performed for each of the areas divided from the target area. In order to divide the target area, the target area may be separated in a grid shape, or the target area may be divided by a freely set group of boundaries. After forming the divided areas as described above, the trajectory data that passes through each of the divided areas is extracted based on the determination result of spatial crossing determination, and further each of pieces of the trajectory data is classified on a predetermined time period basis. The predetermined time period may be set to, for example, 1 hour.

The main trajectory detection unit 112 acquires the number of pieces of trajectory data per unit area in each of the trajectory data groups using the trajectory data group classified in Step S41, the data on the corresponding divided area, and the data of the obstacle table of the map DB 133, and a trajectory data group where the acquired trajectory density is a given value or more is detected as the main trajectory (S42). The number of pieces of trajectory data per unit area is acquired by dividing the number of records in the trajectory data group by the area of the corresponding divided area. A value obtained by subtracting the occupied area of an obstacle from the area of the divided area may be used as the area of the divided area.

After detecting the main trajectory, the main trajectory detection unit 112 acquires the area of the main trajectory and the angle of the traveling direction of the main trajectory (S42). As the area of the main trajectory, a divided area corresponding to the trajectory data group detected as the main trajectory may be set.

When the traveling direction of the main trajectory is acquired, the trajectory data is classified by the traveling direction first. The main trajectory detection unit 112 may divide an angle range of, for example, −180 degrees to 180 degrees into an appropriate number of ranges, may determine the divided range to which the angle of the traveling direction of the trajectory data belongs, and may calculate the angle of the traveling direction based on the determination result.

The main trajectory detection unit 112 may apply an appropriate clustering method to the distribution of the number of pieces of trajectory data for each of the traveling directions to determine the angle of the traveling direction based on the probability that the trajectory data belongs to each of the clusters. At this time, it may be determined that the trajectory data belongs to the cluster having the highest probability. As the clustering method, for example, k-means or EM algorithm may also be used. In the classified trajectory data group, a trajectory data group having the maximum number of pieces of trajectory data per unit area is detected, and the angle of the traveling direction of the detected trajectory data group is set. Regarding the detected data, the current main trajectory data detected from the trajectory data group in the time period including the current time is stored in the main trajectory DB 134. The main trajectory detection unit 112 transmits the current main trajectory data and the subsequent main trajectory data that is detected based on the predicted trajectory data to the queue planning unit 114 (S42).

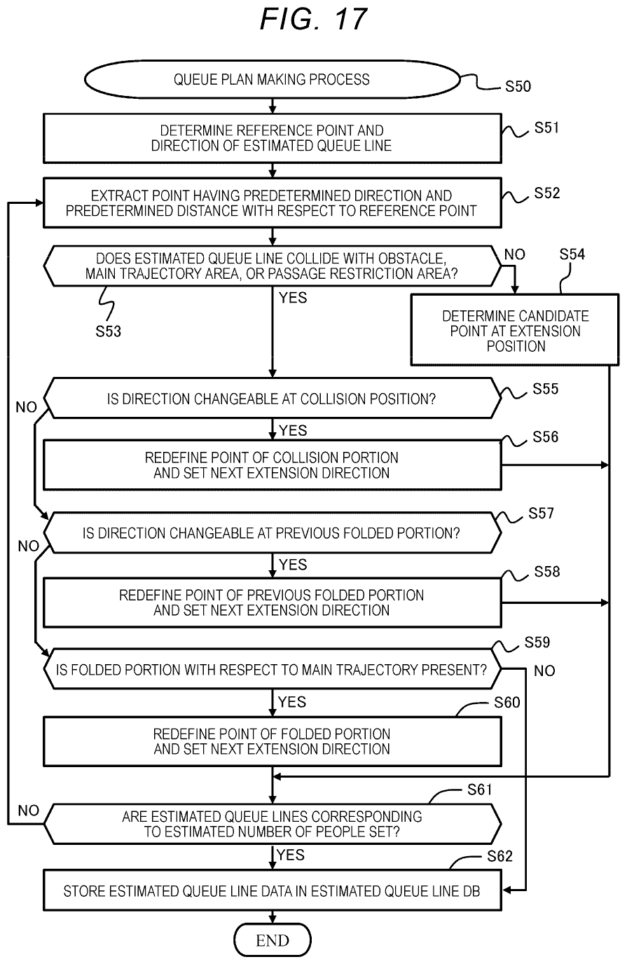

A queue planning process S50 that is executed by the queue planning unit 114 will be described using a flowchart of FIG. 17.

The queue planning unit 114 determines a reference point and a direction when the update of the estimated queue line starts (S51). After Step S52, the next estimated guidance position is determined based on the reference point and the predetermined extension direction, and the determined estimated guidance position is repeatedly updated to a new reference point to generate the estimated queue line.

In Step S51, in a case where a person is already lined up on the queue when the estimated queue line is defined, the estimated guidance positions on the estimated queue line until the portion where the person is already lined up do not change, and only the estimated guidance positions after the end of the current queue are redefined. When the estimated queue line until the portion where the person is already lined up is modified to guide the people to the modified line, a plurality of people who are already lined up on the queue are moved, which may cause confusion.

Step S51 is a process for avoiding this situation. Instead, without performing Step S51, an update start point of the estimated queue line may be determined as the next position of the start of each queue. Alternatively, for example, when the estimated number of people of the queue increases such that the estimated queue line is longer than the currently defined estimated queue line, an estimated guidance position corresponding to the end of the estimated queue line may be set as the reference point.

In Step S51, for example, first, whether the number of people lined up on the queue at the current time is two or more is determined based on the queue state data of the queue state DB 132. As a result of the determination, when the number of people lined up on the queue is zero or one, the reference point at the start of the update is set to the start point of each queue stored in the queue line definition condition table 135T1, and the extension direction is set to the initial direction 1353 of the corresponding queue.

When the number of people lined up on the queue is two or more, a point corresponding to the end of the current queue is extracted as the reference point from the estimated guidance position on the estimated queue line. This process is executed using the same method as that of Step S31 using the trajectory data of the trajectory DB 131, the queue state data of the queue state DB 132, and the estimated queue line data of the estimated queue line DB 136.

The extension direction is set to an immediately previous extension direction, that is, a direction of a line segment that connects the reference point and the immediately previous estimated guidance position. When the number of people who are already lined up on the queue is more than or equal to the estimated number of people stored in the queue estimated number-of-people table, Step S51 may be performed without defining the estimated queue line for the queue or after resetting a value obtained by adding any number to the current estimated number of people to the estimated person capacity of the queue.

The queue planning unit 114 extracts a point having a predetermined direction and a predetermined distance with respect to the reference point as a candidate point (S52).

Any value (for example, 1 m) can be set to the distance. Based on the data of the main trajectory DB 134, the queue planning unit 114 determines whether the candidate point is in the main trajectory area and whether the extension direction at this time is orthogonal to the traveling direction of the main trajectory. When the determination result is YES, the queue planning unit 114 re-extracts, as a candidate point, a point that is at a distance of any length from the predetermined distance. The reason for this is that, when the queue on the main trajectory extends in a direction orthogonal to the traveling direction, the queue interval increases to prevent interference with pedestrians.

Note that the determination conditions are not limited to the case where the extension direction of the queue is orthogonal to the traveling direction of the main trajectory. The determination conditions are also applicable to a case where the estimated queue line crosses the traveling direction of the main trajectory at a different angle. The reason for this is that the density of people on the main trajectory is reduced irrespective of the extension direction of the queue to relieve congestion.

When the estimated queue line extends to the candidate point, the queue planning unit 114 determines whether the estimated queue line collides with the obstacle, the main trajectory area, or the passage restriction area (S53).

The queue planning unit 114 determines whether the candidate point is present on the obstacle, the main trajectory area, or the passage restriction area, for example, based on the map data group of the map DB 133 and the main trajectory data of the main trajectory DB 134. When the determination result is YES, the process proceeds to Step S55. When the determination result is NO, the process proceeds to Step S53. As the main trajectory data, not only the data stored in the main trajectory DB 134 but also the main trajectory data detected based on the trajectory data predicted by the trajectory prediction unit 111 may be used in combination.

The queue planning unit 114 determines the candidate point extracted in Step S52 as the next extension position of the estimated queue line, and updates the estimated queue line (S54). The queue planning unit 114 sets the reference point during the determination of the next extension position to the extension position determined in Step S54, and sets the current extension direction as the direction.

In the collision portion determined in Step S53, the queue planning unit 114 determines whether the extension direction of the queue is changeable (S55).

The queue planning unit 114 extracts, for example, points at a predetermined distance from the reference point at the corresponding time point in some directions as candidate points. As the extension directions to be searched for, directions obtained by equally dividing a range of angles −90 degrees and 90 degrees by any number counterclockwise with respect to the current extension direction are used. The direction of 0 degrees matches with the current extension direction and thus is removed.

For example, a direction that is rotated clockwise from the reference direction by 90 degrees and a direction that is rotated counterclockwise from the reference direction by 90 degrees are used. This case corresponds to a case where the direction is folded to the left or the right when the queue extends straight and collides with the obstacle or the like.

Next, in order to determine whether the queue collides with another obstacle in the folded direction, the queue planning unit 114 executes the same process as Step S53 on the extracted group of candidate points, and determines whether the number of candidate points where the determination result is NO is one or more. When the determination result is YES, the process proceeds to Step S56. When the determination result is NO, the process proceeds to Step S57.

The queue planning unit 114 determines the next extension position of the estimated queue line from candidate points that do not collide with the obstacle or the like among the candidate points extracted in Step S55 (S56). When a plurality of candidate points are present, the next extension position may be randomly selected. During the determination of the next extension position, the reference point and the extension direction are set as in Step S54.

Step S57 is a process that is executed after determining that the queue cannot extend in any direction from the current reference point in Step S55. The queue planning unit 114 executes the following process (S57).

In a portion where the queue is folded in front of the current reference point, the queue planning unit 114 extracts candidate points in a direction different from the current folded direction. The queue planning unit 114 executes the same process as Step S53 on the extracted candidate points to determine whether the number of candidate points where the determination result is No is one or more. When the determination result is YES, the queue planning unit 114 proceeds to Step S58. When the determination result is NO, the queue planning unit 114 proceeds to Step S59. When there are a plurality of portions where the queue is folded in front of the current reference point, candidate points may be extracted from the plurality of portions to perform the determination.

The queue planning unit 114 selects candidate points that do not collide with the obstacle or the like among the candidate points extracted in Step S57, and deletes the current estimated queue line after the folded portion (S58).

The queue planning unit 114 determines the selected candidate point as the next extension position of the estimated queue line (S58). When a plurality of candidate points are present, the next extension position may be randomly selected, or may be selected such that the length of the estimated queue line that should be deleted during the selection of the candidate point is the minimum. During the determination of the next extension position, the reference point and the extension direction are set as in Step S54.

Step S59 is a process that is executed after determining that the queue cannot extend in any direction from the current reference point and, even after further changing the previous folded portion, the queue cannot extend in Step S57.

In a portion where the queue is folded with respect to the main trajectory area, the queue planning unit 114 extracts candidate points at positions at a predetermined distance in a direction in which the queue is not folded, that is, in a direction in which the queue enters the main trajectory area (S59). At this time, the distance is set to the value L1 that is more than the interval L2 of the estimated queue line in the area other than the main trajectory area by any length as in Step S52.

The queue planning unit 114 executes the same process as Step S53 on the extracted candidate points to determine whether the number of candidate points where the determination result is No is one or more (S59). When the determination result is YES, the queue planning unit 114 proceeds to Step S60. When the determination result is NO, the queue planning unit 114 determines that the estimated queue line cannot further extend and proceeds to Step S62.

When there are a plurality of portions where the queue is folded in front of the current reference point, candidate points may be extracted from the plurality of portions as described above to perform the determination. The estimated queue line transmitted to Step S62 may be the currently defined line, or may be randomly selected from the estimated queue lines before changing the direction in Step S56, S58, or S60. Alternatively, the longest estimated queue line may be selected from the above estimated queue lines.

The queue planning unit 114 selects one of the candidate points extracted in Step S59, and deletes the current estimated queue line after the folded portion (S60). The queue planning unit 114 determines the selected candidate point as the next extension position of the estimated queue line (S60). When a plurality of candidate points are present, the next extension position may be randomly selected, or may be selected such that the length of the estimated queue line that should be deleted during the selection of the candidate point is the minimum. Based on the main trajectory data stored in the main trajectory DB 134, the straight-line distance between each of the candidate points and the main trajectory area is acquired, and the candidate point where the acquired distance is the minimum may be selected. During the determination of the next extension position, the reference point is set as in Step S54. As the extension direction, a direction where the straight-line distance from the candidate point to the main trajectory area is the minimum may be selected or may be set as in Step S54. Alternatively, a direction orthogonal to the traveling direction of the main trajectory may be selected.

The queue planning unit 114 determines whether estimated queue lines corresponding to the estimated number of people in the queue estimated number-of-people table 135T2 are set (S61). When the determination result is YES, the queue planning unit 114 proceeds to Step S62. When the determination result is NO, the queue planning unit 114 proceeds to Step S52.

The queue planning unit 114 stores the data of the defined estimated queue line in the estimated queue line DB 136 (S62). When a plurality of queues are present, the estimated queue lines may be defined in any order, for example, in the order of the QID 1351 of the queue line definition condition table 135T1, and Step S62 may be performed after defining all of the estimated queue lines.

During the definition of the estimated queue line, the process may be performed after treating the previously defined estimated queue lines as obstacles. In addition, based on the trajectory data stored in the trajectory DB 131 and the queue state data stored in the queue state DB 132, the data of the estimated queue line may be extracted and used instead of the estimated queue line.

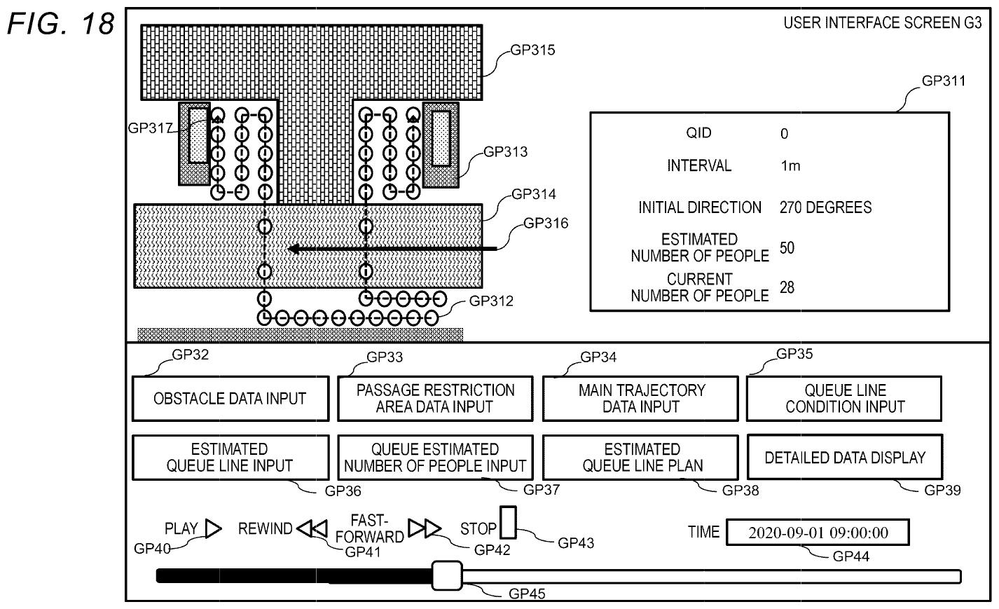

FIG. 18 is an example of a user interface screen G3 that is provided by the population flow guidance system 1 to a user such as a system manager. The screen G3 is a screen that displays the trajectory data stored in the trajectory DB 131 or the map data group stored in the map DB 133, the main trajectory data stored in the main trajectory DB 134, the condition data group stored in the condition DB 135, and the estimated queue line data stored in the estimated queue line DB 136.

On the upper left side of the screen G3, a relationship between the queue and the main trajectory is schematically displayed as display elements GP312 to GP317. On the upper right side of the screen G3, a screen GP311 for displaying the detailed information is displayed. On the lower side of the screen G3, buttons that are operated by the user are displayed as display elements GP32 to GP45.

In each of the trajectory data or the estimated queue line, LINESTRING of each of the records is drawn. The drawing may be performed after marking the end point of LINESTRING or the coordinate group configuring LINESTRING with a marker or after changing the color depending on the states.

When a detailed data display button GP39 is pressed, the detailed information display screen GP311 on the screen G3 displays information regarding the selected trajectory or estimated queue line, the obstacle, the passage restriction area, and the main trajectory. In the example illustrated in the drawing, after the detailed data display button GP39 is pressed, the estimated queue line GP317 is selected. Therefore, the detailed information display screen GP311 displays information on the estimated queue line GP317. This information also includes the data regarding the start point and the queue interval stored in the queue line definition condition table 135T1 of the condition DB 135 or the data regarding the estimated person capacity of the estimated queue line stored in the queue estimated number-of-people table 135T2.

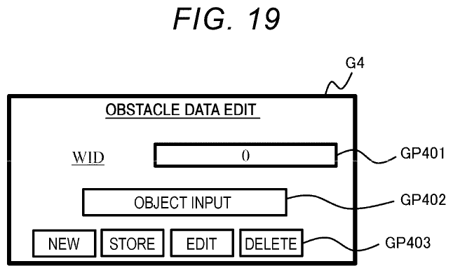

The obstacle data input button GP32 is a button for inputting the obstacle data. When the button GP32 is pressed, an edit screen G4 illustrated in FIG. 19 appears. The user inputs information regarding the obstacle table 133T1 of the map DB 133 from the screen G4. The input information is stored in the obstacle table 133T1 of the map DB 133 by the map data input unit 122.

A passage restriction area data input button GP33 is a button for inputting the passage restriction area data. When the button GP33 is pressed, an edit screen (not illustrated) appears. The screen for editing the passage restriction area data is the same as the screen for editing the obstacle data illustrated in FIG. 19. The user inputs information regarding the passage restriction area table 133T2 of the map DB 133 through the screen GP33. The input information is stored in the passage restriction area table 133T2 of the map DB 133 by the map data input unit 122.

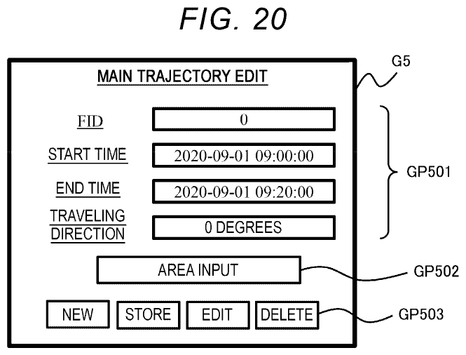

A main trajectory data input button GP34 is a button for inputting the main trajectory data. When the button GP34 is pressed, an edit screen G5 illustrated in FIG. 20 appears. The user can input information regarding the main trajectory table 134T of the main trajectory DB 134 through the screen G5. The input information is stored in the main trajectory DB 134 by the main trajectory data input unit 123.

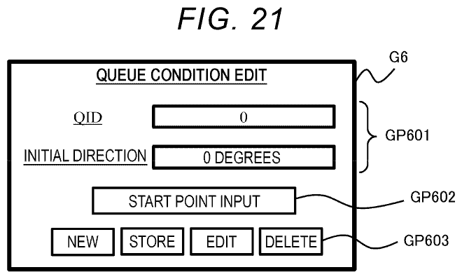

A queue line condition input button GP35 is a button for inputting the definition condition data of the queue line. When this button is pressed, an edit screen G6 illustrated in FIG. 21 appears. The user can input information regarding the queue line definition condition table 135T1 of the condition DB 135 through the screen G6. The input information is stored in the queue line definition condition table 135T1 of the condition DB 135 by the queue condition input unit 124.

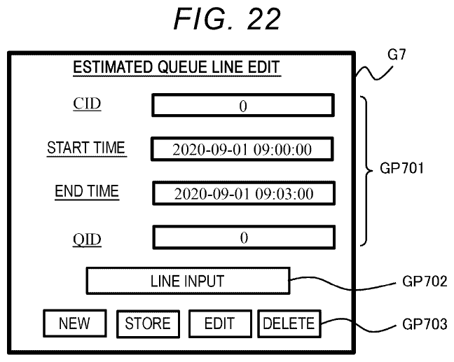

An estimated queue line input button GP36 is a button for inputting the estimated queue line data. When the button GP36 is pressed, an edit screen G7 illustrated in FIG. 22 appears. The user can input information regarding the estimated queue line table 136T of the estimated queue line DB 136. The input information is stored in the estimated queue line DB 136 by the estimated queue line input unit 125.

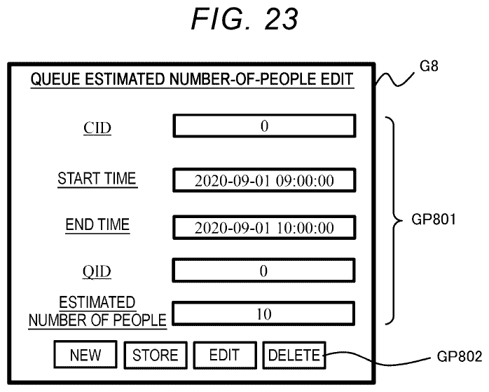

A queue estimated number-of-people input button GP37 is a button for inputting the queue estimated number-of-people data. When the button GP37 is pressed, an edit screen G8 illustrated in FIG. 23 appears. The user can input information regarding the queue estimated number-of-people table 135T2 of the condition DB 135 through the screen G8. The input information is stored in the queue estimated number-of-people table 135T2 of the condition DB 135 by the queue condition input unit 124.

When an estimated queue line planning button GP38 is a button for starting the process of the estimated queue line planning unit 11. When this button GP38 is pressed, the estimated queue line planning process S20 illustrated in FIG. 13 is executed.

The detailed data display button GP39 is a button for causing the screen GP311 to display the detailed information on the data selected through the screen G3. For example, one or more databases corresponding to the selected data are called among the trajectory DB 131, the queue state DB 132, the map DB 133, the main trajectory DB 134, the estimated queue line DB 136, and the condition DB 135, and the information on the selected data is displayed.

A play button GP40 is a button for automatically advancing the time of the data displayed on the screen G3. A rewind button GP41 is a button for rewinding the time of the data displayed on the screen G3. When this button GP41 is pressed, the display time can be rewound to an earlier time. A fast-forward button GP42 is a button for fast-forwarding the time of the data displayed on the screen G3. By pressing this button GP42, when the display time automatically advances, the advance degree thereof can be fast-forwarded. A stop button GP43 is a button for stopping the automatic advance of the time of the data displayed on the screen G3. By pressing this button GP43, when the display time automatically advances, the advance thereof can be stopped.

A bar GP45 is a bar for representing the advanced degree of the time of the data displayed on the screen G3. The user can freely change the time by selecting and moving the bar GP45 to the left or the right.

A display time GP44 is a character string representing the time of the data displayed on the screen G3. The user can edit the character string and can freely change the time.

FIG. 19 is the screen G4 that edits the data of the obstacle table 133T1. In this edit screen G4, the data of the obstacle table 133T1 is edited. The screen G4 includes a portion GP401 representing the value of the WID 1331 of the obstacle table 133T1, a button GP402 for inputting an object, and buttons GP403 such as “New”, “Store” “Edit”, and “Delete”.

The object input button GP402 is a button for starting the edit of a position and a shape of the area 1332 corresponding to the WID 1331 displayed on a text box through the screen G3. When the button GP402 is pressed, the edit of the position and the shape of the area 1332 can be started through the screen G3. A passage restriction area data edit screen (not illustrated) can also be configured as in the screen G4.

FIG. 20 illustrates the screen G5 that edits the data of the main trajectory table 134T. When the main trajectory data input button GP34 is pressed, the edit screen G5 is displayed in the screen G3. In the edit screen G5, the data of the main trajectory table 134T stored in the main trajectory DB 134 can be edited.

The screen G5 includes a text box GP501 representing the respective information on the FID 1341, the start time 1342, the end time 1343, and the traveling direction 1345 of the main trajectory table 134T. An area input button GP502 is a button for starting the edit of a position and a shape of the area 1344 corresponding to the FID 1341 displayed on the text box GP501 through the screen G3. When the button GP502 is pressed, the edit of the position and the shape of the area 1344 can be started through the screen G3.

As in the screen G4, the screen G5 includes buttons GP503 such as “New”, “Store”, “Edit”, and “Delete”.

FIG. 21 is a queue condition edit screen G6. When the queue line condition input button GP35 is pressed, the edit screen G6 is displayed in the screen G3. In the edit screen G6, the information of the queue line definition condition table 135T1 stored in the condition DB 135 is edited.

The screen G6 includes a text box GP601 representing the information regarding the QID 1351 and the initial direction 1353 of the queue line definition condition table 135T1, a button GP602 for inputting the start point, and buttons GP603 such as “New” and “Store”.

The button GP602 is a button for starting the edit of a position and a shape of the start point 1352 corresponding to the QID 1351 displayed in the text box GP601 through the screen G3. When the button GP602 is pressed, the edit of the position and the shape of the start point 1352 can be started through the screen G3.

FIG. 22 is the screen G7 that edits the estimated queue line. When the estimated queue line input button GP36 is pressed, the edit screen G7 is displayed in the screen G3. In the edit screen G7, the information of the estimated queue line table 136T stored in the estimated queue line DB 136 can be edited.

The screen G7 includes a text box GP701 representing the respective information on the CID 1361, the start time 1362, the end time 1363, and the QID 1364 of the estimated queue line table 136T, a line input button GP702, and buttons GP703 such as “New” and “Store”.

The line input button GP702 is a button for starting the edit of a position and a shape of the line corresponding to the CID 1361 displayed on the text box GP701 through the screen G3. When the button GP702 is pressed, the position and the shape of the line can be edited through the screen G3.

FIG. 23 illustrates the queue estimated number-of-people edit screen G8. When the queue estimated number-of-people input button GP37 is pressed, the edit screen G8 is displayed in the screen G3. In the edit screen G8, the information of the queue estimated number-of-people table 135T2 stored in the condition DB 135 is edited.

The screen G8 includes a text box GP801 representing the respective information on the CID 1355, the start time 1356, the end time 1357, the QID 1358, and the estimated number of people 1359 of the queue estimated number-of-people table 135T2 and buttons GP802 such as “New” and “Store”.

According to the embodiment having the above-described configuration, an estimated queue line for guiding a service user to a queue of service users is planned such that at least a part of the queue of the service users crosses a main trajectory. As a result, for example, even during congestion, the population flow guidance system 1 can organize and manage a queue for receiving a service.

In the population flow guidance system 1 according to the embodiment, in an overlapping area where the queue crosses an area of a main trajectory, an interval L1 of the service users is set to be wider than an interval L2 in normal times. Therefore, the flow of people in the facility 2 can be made smooth without interfering with the movement of pedestrians who do not use the service.

In the population flow guidance system 1 according to the embodiment, the number of people to be lined up on the queue is predicted, and the estimated queue line at least a part of which crosses the area of the main trajectory is planned such that the predicted number of people can be accommodated in the estimated queue line. Therefore, even a queue of a large number of people can also be handled.

The population flow guidance system 1 according to the embodiment includes the queue guidance unit 21. Therefore, even when the estimated queue line and the main trajectory area cross each other, the well-organized queue can be maintained by notifying an appropriate waiting position and an appropriate action instruction (for example, an instruction to advance, stop, or increase the interval).

The population flow guidance system 1 according to the embodiment notifies not only the people who are lined up on the queue but also pedestrians configuring the main trajectory of the presence of the queue. Therefore, the smooth movement of the pedestrians can be implemented, and the convenience of the service users, the pedestrians, the manager of the facility 2, and the like is improved.

The population flow guidance system 1 according to the embodiment includes the queue information providing unit 16. Therefore, for example, the convenience of the manager of the facility 2, other service providers of the facility 2, or a marketer is improved.

The present invention is not limited to the embodiment and includes various modification examples. For example, the embodiments have been described in detail in order to easily describe the present invention, and the present invention is not necessary to include all the configurations described above. In addition, a part of the configuration of one embodiment can be replaced with the configuration of another embodiment. Further, the configuration of one embodiment can be added to the configuration of another embodiment. In addition, addition, deletion, and replacement of another configuration can be made for a part of the configuration of each of the embodiments.

What is claimed is:

1. A moving body queue management system that manages a queue of moving bodies, the system comprising:
an information management unit configured to manage moving information regarding movement of a moving body; and
an estimated queue line planning unit configured to plan an estimated queue line for guiding the moving body to the queue based on the moving information such that at least a part of the queue of the moving bodies crosses a main trajectory.

2. The moving body queue management system according to claim 1,
wherein the estimated queue line planning unit plans the estimated queue line such that a distance between adjacent moving bodies varies between a first area where the queue overlaps the main trajectory and an area other than the first area.

3. The moving body queue management system according to claim 2,
wherein the estimated queue line planning unit sets the distance between adjacent moving bodies in the first area to be longer than the distance between adjacent moving bodies in the area other than the first area.

4. The moving body queue management system according to claim 1,
wherein the estimated queue line planning unit predicts a length of the queue of the moving bodies and plans the estimated queue line based on the predicted length of the queue of the moving bodies and a direction of the main trajectory.

5. The moving body queue management system according to claim 1, further comprising a queue guidance unit configured to guide at least a next moving body to be lined up on the queue to a waiting position based on the estimated queue line.

6. The moving body queue management system according to claim 5,
wherein the queue guidance unit further provides guidance to other moving bodies that are moving on the main trajectory about presence of the moving body that is waiting at the waiting position.

7. The moving body queue management system according to claim 5, further comprising a queue information providing unit configured to provide at least a part of the information managed by the information management unit to a calculation system relating to a source from which the queue is formed.

8. A moving body queue management method of managing a queue of moving bodies using a computer, the method comprising:
by the computer
managing moving information regarding movement of a moving body; and
planning an estimated queue line for guiding the moving body to the queue based on the moving information such that at least a part of the queue of the moving bodies crosses a main trajectory.

9. A computer program for causing a computer to function as moving body queue management for managing a queue of moving bodies, the computer program causing the computer to implement as:
an information management unit configured to manage moving information regarding movement of a moving body; and
an estimated queue line planning unit configured to plan an estimated queue line for guiding the moving body to the queue based on the moving information such that at least a part of the queue of the moving bodies crosses a main trajectory.
